(19) United States
(12) Patent Application Publication
(10) Pub. No.: US 2023/0397605 A1
(43) Pub. Date: Dec. 14, 2023

(54) METHODS FOR IMPROVING PLANT GROWTH AND CROP YIELD BY USING COMPOUNDS OF TRISULPHIDE OR TETRASULPHIDE

(71) Applicant: UNIVERSITY OF IOWA RESEARCH FOUNDATION, Iowa City, IA (US)

(72) Inventors: Ned B. BOWDEN, Iowa Cidty, IA (US); Erin E. IRISH, Iowa Cidty, IA (US); Aliasgar SALEM, Iowa City, IA (US); Justin M. CARTER, Iowa City, IA (US); Eric M. BROWN, Iowa City, IA (US)

(73) Assignee: UNIVERSITY OF IOWA RESEARCH FOUNDATION, Iowa City, IA (US)

(21) Appl. No.: 18/032,768

(22) PCT Filed: Oct. 19, 2021
(86) PCT No.: PCT/US2021/055687

§ 371 Date: Apr. 19, 2023

Related U.S. Application Data
(60) Provisional application No. 63/094,114, filed on Oct. 20, 2020.

(51) Int. Cl. A01N 31/04; A01C 1/06; A01N 37/46

(52) U.S. Cl. CPC A01N 31/04; A01C 1/06; A01N 37/46

(57) ABSTRACT

The invention provides a method for increasing the growth of a plant or the harvest yield of a plant comprising, contacting the plant with a trisulfide or a tetrasulfide. The methods of the invention may conveniently be employed in indoor growth facilities or in conjunction with a hydroponic growth system.

### CROSS-REFERENCE TO RELATED APPLICATION

This application claims priority to U.S. Provisional Application No. 63/094,114 that was filed on Oct. 20, 2020. The entire content of the applications referenced above is hereby incorporated by reference herein.

### GOVERNMENT FUNDING

This invention was made with government support wider 2018-67030-27352 awarded by the United States Department of Agriculture and under PFI1827336 awarded by the National Science Foundation. The government has certain rights in this invention.

### BACKGROUND

The worldwide population is expected to grow from its current level of 7.2 B to 9.6 B people by 2050 (United Nations, Department of Economic and Social Affairs, Population Division (2013). World Population Prospects: The 2012 Revision, Highlights and Advance Tables. Working Paper No. ESA/P/WP.228; Foley JA, et al., Nature 2011; 478:337-42; and Godfray H C J B, et al., Science. 2010; 327:812-8). To meet the needs of the world's growing human population, it is projected that global food production must increase 70% by 2050 (www.fao.org/fileadmin/templates/wsfs/docs/expert_paper/How_to_Feed_the_World_in_2050.pdf). Aside from sheer population numbers, there are additional factors that will increase market demand for food production. Trends indicate that as developing countries urbanize and their economies grow, their consumption of meat and dairy products will also increase. Because the conversion of feed to livestock is inefficient (for instance, each pound of hamburger requires 52 pounds of feed grain over a cow's lifetime; Capper J L., Animals. 2012; 2:127-43) growth in this sector creates an increasing demand for cereal crops. Biofuel production may drive cereal demands even higher. Yet the amount of land dedicated to farming has remained at 1992 levels both in the United. States and worldwide, which has led to a decrease in agricultural area per capita from 0.44 hectares per capita in 1960 to 0.17 hectares per capita in 2025. Current advances in technology cannot increase the yield per acre of crops enough to teed the growing population; new innovations are needed. Solutions must be environmentally safe, nonpolluting, and should help crops survive droughts and other environmental stressors that affect their growth.

One partial solution to this problem is the application of hydrogen sulfide (H₂S) to increase the growth, survival, and yields of crops. H₂S is a gasotransmitter that is synthesized enzymatically in plants and used as a signaling molecule. Research in the last dozen years has repeatedly demonstrated that low doses of H₂S have dramatic effects, including increased growth of roots, protection against heat stress and drought conditions, increased overall size and mass, alleviation from freezing stress on leaves, protection from high water salinity, and prolonged fruit shelf life (Guo H, et al., Acta Physiol Plant. 2016; 38(1)1-13; Shi H, et al., Plant Phys Biochem. 2013; 71:226-34; Hu L-Y, et al., J Agric Food Sci. 2012; 60:8684-93; Li Z-R, et al., HortScience. 2015; 50(3):416-20; Li Y-J, et al., J Agric Food Chem. 2014; 62:1119-29, and Christou A, et al., J Exper Botany. 2013; 64(7):1953-66). Two of the challenges of working with H₂S is that it is a low boiling point gas (boiling point=−60° C.), and it is highly toxic. Exposure to levels of 2 ppm of H₂S in the air can lead to negative health effects such as headaches or breathing problems for people who suffer from asthma, and exposure to 100 ppm is “immediately dangerous to life and health” (www.osha.gov/SLTC/hydrogensulfide/hazards.html).

The investigation of H₂S in plants is a new field—much of the key work has been completed since 2007—yet it has already been shown to have positive effects on corn, soybeans, wheat, sweet potatoes, cucumbers, strawberries, rice, spinach, tomatoes, broccoli, kiwi, and more. (Duan B, et al., Plant Growth Regul. 2015; 75:33-44; Li Z-G, et al., J Plant Phys. 2013; 170:741-7; Li Z G. Russian J Plant Phys. 2013; 60:733-40; Alvarez C, et al., Arabidopsis. Plant Physiol. 2010; 152(2):656-69; Bloem E, et al., J Agron Crop Sci. 2011; 197(4):311-21; Chen J, et al., J Exp Bot. 2011; 62(13):4481-93; Christou A, et al., J Exp Bot. 2013; 64(7):1953-66; Fang T, et al., Plant Physiol Biochem. 2014; 76:44-51; Fu P, et al., L. Acta Soc Bot Pol. 2013; 82(4):295-302; Gao S-P. et al.; HortScience. 2013; 48(11):1385-92; Garcia-Mata C, et al., New Phytol. 2010; 188(4):977-84; Hou Z, et al., J lntegr Plant Biol. 2013; 55(3):277-89; Hu L-Y, et al., J Agric Food Chem. 2012; 60(35):8684-93; Krasensky J, et al., J Exp Bot. 2012; 63(4):1593-608; Li S-P, et al., J Agric Food Chem. 2014; 62(5):1119-29; Li Z-G, et al., Acta Physiol Plant. 2012; 34(6):2207-13; Lin Y-T, et al., J Plant Growth Regul. 2012; 31(4):519-28; Liu J, et al., Chin Sci Bull. 2011; 56(33):3547-53, Papenbrock J, et al., Plant Biol. 2007; 9(5):582-8; Shi H, et al., Plant Physiol Biochem. 2014; 74:99-107; Sun Y, et al., J Food, Agric Environ. 2013; 11(3 & 4, Pt. 2):1097-100; Wang B-L, et al., Planta. 2010; 231(6):1301-9; Yadav S K. S Afr J Bot. 2010;76(2):167-79; Zhang H, et al., Postharvest Biol Technol. 2011; 60(3):251-7; Zhang H, et al., J Integr Plant Biol. 2009; 51(12):1086-94; and Zhang H, et al., Plant Growth Regul. 2009; 58(3):243-50).

Carter et al, have shown that the compound GYY-4137, which slowly releases H₂S by hydrolysis, increased the growth of radish, peas, and lettuce plants and that the harvest yield of radishes doubled when milligram loadings of GYY-4137 were applied (Carter J M, et al., PLoS ONE 13(12): e0208732; doi.org/10.1371/journal.pone.0208732),

Using chemicals that release hydrogen sulfide to grow plants indoors is particularly challenging because hydrogen sulfide is a highly poisonous gas. This problem is even more acute to grow plants indoors using hydroponics where plants are grown in nutrient-rich water. Chemicals such as GYY-4137 react with water to release hydrogen sulfide, but they also release hydrogen sulfide that escapes into the atmosphere. In a controlled, indoor environment this release of hydrogen sulfide into the atmosphere would be a large problem. Accordingly, there is currently a need for compounds and methods that release hydrogen sulfide under different conditions and primarily within plants. A desired system would release hydrogen sulfide when a chemical is taken into plants, but this chemical should be mostly stable in water and not release hydrogen sulfide at detectable levels. In particular, there is a need for compounds and methods that can be used to release hydrogen sulfide and increase plant growth and crop yield in a hydroponic growth system.

### SUMMARY

The invention also provides a method for increasing growth or harvest yield of a plant comprising, providing H₂S to the plant through degradation of a tri- or tetra-sulfide. The H₂S can be provided to the plant by contacting a seed of the plant with the tri- or tetra-sulfide, contacting the plant with the tri- or tetra-sulfide, contacting soil on or around the seed or plant with the tri- or tetra-sulfide, or by placing a container comprising the tri- or tetra-sulfide proximal to the plant or the seed, so that H₂S is provided to the plant or the seed. In one embodiment, the invention provides a method comprising ; degrading a tri- or tetra-sulfide to provide H₂S. In one embodiment, the invention provides a method comprising, providing H₂S to a plant or a seed by degrading a tri- or tetra-sulfide. In one embodiment, the invention provides a method comprising, increasing growth or harvest yield by providing H₂S to a plant or a seed through degradation of a tri- or tetra-sulfide.

Tri- and tetra-sulfides provide a controlled release of hydrogen sulfide in a plant around thiols such as cysteine and glutathione that are naturally present within plants, but not in water in the absence of thiols. Accordingly, the methods of the invention can be used to deliver hydrogen sulfide to a plant, without polluting the atmosphere with an unacceptable amount of hydrogen sulfide. The methods of the invention are particularly useful for increasing the growth and harvest yields of crops in indoor farms and greenhouses and in hydroponic growth systems.

The invention provides a method for increasing the growth of a plant or the harvest yield of a plant comprising, contacting the plant with a trisulfide or a tetrasulfide.

The invention also provides a method for increasing the growth of a plant or the harvest yield of a plant that grows from a seed, comprising contacting the seed with a trisulfide or a tetrasulfide.

The invention also provides a method for increasing the growth of a plant or the harvest yield of a plant comprising, applying a trisulfide or a tetrasulfide to the immediate area around a plant wherein the plant or a seed of the plant has been planted, or will be planted.

The invention also provides a method comprising growing a plant in a hydroponic growth system that comprises a trisulfide or a tetrasulfide.

The invention also provides a method for increasing the growth of a plant or the harvest yield of a plant that is grown in a hydroponic medium comprising, adding a tri-sulfide or a tetra-sulfide to the medium.

The invention also provides a composition for releasing H₂S in a plant comprising a trisulfide or a tetrasulfide.

The invention also provides a kit comprising a trisulfide or a tetrasulfide, packaging material, and instructions for using the trisulfide or the tetrasulfide to increasing the growth or harvest yield of the plant.

### BRIEF DESCRIPTION OF THE FIGURES

FIG. 1 shows data from Example 1.

### DETAILED DESCRIPTION

The following definitions are used, unless otherwise described: halo or halogen is fluoro, chloro, bromo, or iodo. Alkyl, alkoxy, alkenyl, alkynyl, etc. denote both straight and branched groups; but reference to an individual radical such as propyl embraces only the straight chain radical, a branched chain isomer such as isopropyl being specifically referred to.

The term “alkyl”, by itself or as part of another substituent, means, unless otherwise stated, a straight or branched chain hydrocarbon radical, having the number of carbon atoms designated (i.e., C₁₋₈ means one to eight carbons). Examples include (C₁-C₈)alkyl, (C₂-C₈)alkyl, C₁-C₆)alkyl, (C₂-C₆)alkyl and (C₃-C₆)alkyl. Examples of alkyl groups include methyl, ethyl, n-propyl, iso-propyl, n-butyl, t-butyl, iso-butyl, sec-butyl, n-pentyl, n-hexyl, n-heptyl, n-octyl, and and higher homologs and isomers.

The term “alkenyl”, by itself or as part of another substituent, means, unless otherwise an alkyl as defined above, that contains one or more (e.g. 1, 2, 3, or 4) double bonds.

The term “alkenyl”, by itself or as part of another substituent, means, unless otherwise an alkyl as defined above, that contains one or more (e.g. 1, 2, 3, or 4) triple bonds.

The phrase “increase the growth of a plant” includes increasing the mass of the plant or the height of the plant. In one embodiment, the mass of the plant is increased by at least about 5%. In another embodiment, the mass of the plant is increased by at least about 10%. In another embodiment, the mass of the plant is increased by at least about 20%. In one embodiment, the height of the plant is increased by at least about 5%. In another embodiment, the height of the plant is increased by at least about 10%. In another embodiment, the height of the plant is increased by at least about 20%.

The phrase “increase the harvest yield of a plant” includes increasing the yield (e.g. volume or mass) of the harvested material from a plant. In one embodiment, the harvest yield of the plant is increased by at least about 1%. In another embodiment, the harvest yield of the plant is increased by at least about 3%. In another embodiment, the harvest yield of the plant is increased by at least about 10%. In another embodiment, the harvest yield of the plant is increased by at least about 20%.

The term “hydroponic growth system” includes any plant growth process that involves growing plants in or on an aqueous medium. For example, the term includes solid support systems, wick systems, water culture systems, root dipping, hanging bag, trench method, aquaponics, ebb and flow systems, drip systems, nutrient film technology, and aeroponic systems. In one embodiment, the term includes any plant growth process that involves growing plants in the absence of soil. Typically, plants are grown in a growth medium that includes water and nutrients. (Soilless Farming—The next generation green revolution; soilless cultivation its various types and application in agricultural and pharmaceutical sector 2017)

The “growth medium” is the presence of any solid support for the plants and how the nutrients are added to the plants. The plants may be supported in a porous, solid medium such as clay, coconut fiber, or many more options or the plants may not be supported in a porous solid support for part of their lifetime. The nutrients are dissolved or suspended in an aqueous phase and delivered to the roots, leaves, or stems of the plants. In this patent, the delivery of the nutrients in any location on the plant is considered part of the growth medium.

The phrase “providing H₂S to a plant” includes providing H₂S so that it contacts the plant as well as providing H₂S so that it contacts a seed of the plant.

The term “residue” as it applies to the residue of a compound refers to a compound that has been modified in any manner which results in the creation of an open valence wherein the site of the open valence. The open valence can be created by the removal of 1 or more atoms from the compound (e.g., removal of a single atom such as hydrogen or removal of more than one atom such as a group of atoms including but not limited to an amine, hydroxyl, methyl, amide (e.g., —C(═O)NH₂) or acetyl group). The open valence can also be created by the chemical conversion of a first function group of the compound to a second functional group of the compound (e.g., reduction of a carbonyl group, replacement of a carbonyl group with an amine,) followed by the removal of 1 or more atoms from the second functional group to create the open valence.

The trisulfide or tetrasulfides disclosed herein can exist as tautomeric isomers in certain cases. Although only one delocalized resonance structure may be depicted, all such forms are contemplated within the scope of the invention.

Stereochemical definitions and conventions used herein generally follow S. P. Parker, Ed., McGraw-Hill Dictionary of Chemical Terms (1984) McGraw-Hill Book Company, New York; and Eliel, E. and Wilen, S., “Stereochemistry of Organic Compounds”, John Wiley & Sons, Inc., New York, 1994. The trisulfides and tetrasulfides can contain asymmetric or chiral centers, and therefore exist in different stereoisomeric forms. It is intended that all stereoisomeric forms of the trisulfides and tetrasulfides, including but not limited to, diastereomers, enantiomers and atropisomers, as well as mixtures thereof such as racemic mixtures, form part of the present invention. Many organic compounds exist in optically active forms, i.e., they have the ability to rotate the plane of plane-polarized light. In describing an optically active compound, the prefixes D and L, or R and S, are used to denote the absolute configuration of the molecule about its chiral center(s). The prefixes d and l or (+) and (−) are employed to designate the sign of rotation of plane-polarized light by the compound, with (−) or l meaning that the compound is levorotatory. A compound prefixed with (+) or d is dextrorotatory. For a given chemical structure, these stereoisomers are identical except that they are mirror images of one another. A specific stereoisomer can also be referred to as an enantiomer, and a mixture of such isomers is often called an enantiomeric mixture. A 50:50 mixture of enantiomers is referred to as a racemic mixture or a racemate, which can occur where there has been no stereoselection or stereospecificity in a chemical reaction or process. The terms “racemic mixture” and “racemate” refer to an equimolar mixture of two enantiomeric species, devoid of optical activity.

It will be appreciated by those skilled in the art that trisulfides and tetrasulfides having a chiral center may exist in and be isolated in optically active and racemic forms. Some trisulfides and tetrasulfides may exhibit polymorphism. It is to be understood that the present invention encompasses the use of any racemic, optically-active, polymorphic, or stereoisomeric form, or mixtures thereof, which possess the useful properties described herein, it being well known in the art how to prepare optically active forms (for example, by resolution of the racemic form by recrystallization techniques, by synthesis from optically-active starting materials, by chiral synthesis, or by chromatographic separation using a chiral stationary phase.

When a bond herein is drawn in a non-stereochemical manner (e.g. flat), the atom to which the bond is attached includes all stereochemical possibilities. When a bond is drawn in a defined stereochemical manner (e.g. bold, bold-wedge, dashed or dashed-wedge), it is to be understood that the atom to which the stereochemical bond is attached is enriched in the absolute stereoisomer depicted unless otherwise noted. In one embodiment, the compound may be at least 51% the absolute stereoisomer depicted. In another embodiment, the compound may be at least 60% the absolute stereoisomer depicted. In another embodiment, the compound may be at least 80% the absolute stereoisomer depicted. In another embodiment, the compound may be at least 90% the absolute stereoisomer depicted. In another embodiment, the compound may be at least 95 the absolute stereoisomer depicted. In another embodiment, the compound may be at least 99% the absolute stereoisomer depicted.

The trisulfides and tetrasulfides may optionally be delivered with other fertilizers, pesticides, and/or herbicides. Alternatively, they may be delivered with water or as a neat solid or solution. The compounds may be added to the seed or to the aqueous nutrients at time of planting, sprayed onto plants at intervals post emergence, or added to the nutrients. In addition the trisulfides and tetrasulfides may be applied to seeds prior to planting using established methods. For example, they may be coated on scads with an inert vehicle, tumbled, and dried. The trisulfides and tetrasulfides may be added at any stage in the growth of a plant and they may be added at multiple times. They may be added to the growth medium (i.e. into water) for the roots or to be sprayed onto the plants. The compounds may be dripped into soil at time of planting, dripped into soil at intervals post emergence, sprayed onto the roots of plants, or dripped on the foiliage of a plant. The compounds may be delivered with drip flow or other irrigation methods.

The trisulfides and tetrasulfides can be formulated in a variety of ways. For example, they can be formulated as a dustable powder, gel, a wettable powder, a water dispersible granule, a water-dispersable or water-foaming tablet, a briquette, an emulsifiable concentrate, a microemulsifiable concentrate, an oil-in-water emulsion, a water-in-oil emulsion, a dispersion in water, a dispersion in oil, a suspoemulsion, a soluble liquid (with either water or an organic solvent as the carrier), an impregnated polymer film, or other forms known in the art. These formulations may be suitable for direct application or may be suitable for dilution prior to application, said dilution being made either with water, liquid fertilizer, micronutrients, biological organisms, oil or solvent. The compositions are prepared by admixing the active ingredient with adjuvants including diluents, extenders, carriers, and conditioning agents to provide compositions in the form of finely-divided particulate solids, granules, pellets, solutions, dispersions or emulsions. Thus, it is believed that the active ingredient could be used with an adjuvant such as a finely-divided solid, a mineral oil, a liquid of organic origin, water, various surface active agents or any suitable combination of these. In one embodiment, the agricultural carrier comprises water, DMSO, a poly(ethylene glycol), glycerine, oliogoethylene glycol, an alcohol, a heterocyclic alcohol, or NMP.

For hydroponic applications, the trisulfides and tetrasulfides may be formulated neat or formulated as a salt.

The active ingredient may also be contained in very fine microcapsules in polymeric substances. Microcapsules typically contain the active material enclosed in an inert porous shell which allows escape of the enclosed material to the surrounds at controlled rates. Encapsulated droplets are typically about 0.1 to 500 microns in diameter. The enclosed material typically constitutes about 25 to 95% of the weight of the capsule. The active ingredient may be present as a monolithic solid, as finely dispersed solid particles in either a solid or a liquid, or it may be present as a solution in a suitable solvent. Shell membrane materials include natural and synthetic rubbers, cellulosic materials, styrene-butadiene copolymers, polyacrylonitriles, polyacrylates, polyesters, polyamides, polyureas, polyurethanes, natural polymers, other polymers familiar to one skilled in the art, chemically-modified polymers and starch xanthates. Alternative very fine microcapsules may be formed wherein the active ingredient is dispersed as finely divided particles within a matrix of solid material, but no shell wall surrounds the microcapsule.

Suitable agricultural adjuvants and carriers that are useful in preparing the compositions of the invention are well known to those skilled in the art.

Liquid carriers that can be employed include water, toluene, xylene, petroleum naphtha, crop oil, acetone, methyl ethyl ketone, cyclohexanone, acetic anhydride, acetonitrile, acetophenone, amyl acetate, 2-butanone, chloroberizene, cyclohexane, cyclohexanol, alkyl acetates, diacetonalcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethyl formamide, dimethyl sulfoxide, 1,4-dioxane, dipropylene glycol, dipropylene glycol methyl ether, dipropyleneizlycol dibenzoate, diproxitol, alkyl pyrrolidinone, ethyl acetate, 2-ethyl hexanol, ethylene carbonate, 1,1,1-trichloroethane, 2-heptanone, alpha pinene, d-limonene, ethylene glycol, ethylene glycol butyl ether, ethylene glycol methyl ether, gamma-butyrolactone, glycerol, glycerol diacetate, glycerol monoacetate, glycerol triacetate, glycerol triacetate, hexadecane, hexylene glycol, isoamyl acetate, isobornyl acetate, isooctane, isophorone, isopropyl benzene, isopropyl myristate, lactic acid, laurylamine, mesityl oxide, methoxy-propanol, methyl isoamyl ketone, methyl isobutyl ketone, methyl laurate, methyl octanoate, methyl oleate, methylene chloride, m-xylene, n-hexane, n-octylamine, octyl amine acetate, oleylamine, o-xylene, phenol, polyethylene glycol (PEG400), propionic acid, propylene glycol, propylene glycol monomethyl ether, propylene glycol mono-methyl ether, p-xylene, toluene, triethyl phosphate, triethylene glycol, xylene sulfonic acid, trichloroethylene, perchloroethylene, ethyl acetate, amyl acetate, butyl acetate, propylene glycol monomethyl ether and diethylene glycol monomethyl ether, methanol, ethanol, isopropanol, and higher molecular weight alcohols such as amyl alcohol, tetrahydrofurfuryl alcohol, hexanol, octanol etc., ethylene glycol, propylene glycol, glycerine, N-methyl-2-pyrrolidinone, and the like. Water is generally the carrier of choice for the dilution of concentrates.

Suitable solid carriers include talc, titanium dioxide, pyrophyllite clay, silica, attapulgite clay, kieselguhr, chalk, diatomaceous earth, lime, calcium carbonate, bentonite clay, Fuller's earth, cotton seed hulls, wheat flour, soybean flour, pumice, wood flour, walnut shell flour, lignin, and the like such as described in the CFR 180.1001, (c) & (d).

A broad range of surface-active agents can be employed in both solid and liquid compositions, especially those designed to be diluted with carrier before application. Suitable surface-active compounds are nonionic, cationic and/or anionic surfactants and surfactant mixtures haying good emulsifying, dispersing and wetting properties. Examples of suitable surfactants and surfactant mixtures are given in U.S. Pat. Nos. 5,958,835; 6,063,732 and 6,165,939. Also the surfactants customarily used for the art of formulation and described, inter alia, in “McCutcheon's Detergents and Emulsifiers Annual” MC Publishing Corp., Ridgewood N.J., 1981, Stache, H., “Tensid-Taschenbuch” (Handbook of Surfactants), Carl Hanser Verlag, Munich/Vienna, 1981, and M. and J. Ash, “Encyclopedia of Surfactants”, Vol I-III, Chemical Publishing Co., New York, 1980-81 are suitable for manufacture of the herbicides according to the invention.

The formulations of the invention can comprise the trisulfides and tetrasulfides in any suitable concentration. In one embodiment, for example, the formulation may include the trisulfides and tetrasulfides in about 95, 90, 80, 60, 50, 40, 30, 20, 10, 5, 2, 1, 0.5 or 0.01 weight percent of the formulation. The formulations may also include other fertilizers or pesticides, which may also be present in any suitable concentration.

The trisulfides and tetrasulfides can be applied in water with or without nutrients at any acceptable rate. For example, the compounds can be applied at a rate of at least about 1 gram per 150 gallons, at least about 5 grams per 150 gallons, at least about 20 grams per 150 gallons, at least about 50 grams per 150 gallons, or at least about 100 grams per 150 gallons, although higher application rates are not excluded. When the tri and tetrasulfides are added to a nutrient bath, only ppm loadings may be required, however, higher concentrations may be used. When the tri and tetrasulfides are sprayed onto the roots as in aeroponics, the concentration may be higher than ppm, since that method uses less water. When the tri and tetrasulfides are applied directly to the leaves, the loading levels may be much higher.

In one embodiment, the trisulfides and tetrasulfides can be dissolved in water, organic solvents, or a mixture thereof, with or without other fertilizers, pesticides, herbicides, or other chemicals to be added to the roots as part of a nutrient solution. The trisulfides and tetrasulfides will typically be in a concentration of from about 1 ppm of the formulation to about 5% by weight of the formulation. In another embodiment, the trisulfides and tetrasulfides can be dissolved in water, organic solvents, or a mixture thereof, with or without other fertilizers, pesticides, herbicides, or other chemicals in a concentration of from about 1 ppt of the formulation to about 1% weight percent of the formulation.

In one embodiment, the trisulfides and tetrasulfides can be dissolved in water, organic solvents, or a mixture thereof, with or without other fertlizers, pesticides, herbicides, or other chemicals to be added to the leaves or stems as part of a nutrient solution. The trisulfides and tetrasulfides will be in a concentration of from about 1 ppm of the formulation to about 75% by weight of the formulation. in another embodiment, the trisulfides and tetrasulfides can be dissolved in water, organic solvents, or a mixture thereof, with or without other fertlizers, pesticides, herbicides, or other chemicals in a concentration of from about 1 ppt of the formulation to about 30% weight percent of the formulation.

In another embodiment, the formulation comprises the trisulfides and tetrasulfides dissolved in water, organic solvents, or a mixture thereof, with other fertlizers, pesticides, herbicides, or other chemicals present, wherein the trisulfide or tetrasulfide is present in less than 5% weight percent of the formulation. In another embodiment, the formulation comprises the trisulfide or tetrasulfide dissolved in water, organic solvents, or a mixture thereof, with other fertlizers, pesticides, herbicides, or other chemicals present, wherein the trisulfide or tetrasulfide is present in less than 1% weight percent of the formulation.

Specific values listed below for radicals, substituents, and ranges, are for illustration only; they do not exclude other defined values or other values within defined ranges for the radicals and substituents. It is to be understood that two or more values may be combined. It is also to be understood that the values listed herein below (or subsets thereof) can be excluded.

Specifically, (C₁-C₂₀)alkyl can be methyl, ethyl, propyl, isopropyl, butyl, iso-butyl, sec-butyl, pentyl, 3-pentyl, hexyl, heptyl, octyl, nonyl, decyl, tuidecyl, dodecyl, tridecyl, tetradecyl, pentadecyl, hexadecyl, heptadecyl, octadecyl, nonadecyl, icosanyl, and (C₃-C₂₀)cycloalkyl can be cyclopropyl, cyclobutyl, cyclopentyl, or cyclohexyl.

In one embodiment, the plant is a root vegetable, a seed vegetable, or a leaf vegetable.

In one embodiment, the plant is a fruit, flower, flowering plant, vegetable, hemp, or cannabis.

In one embodiment, the plant is a pea, lettuce, tomato, cucumber, green bean, broccoli, squash, beat, onion, sugar, sweet corn, sugar beet, barley, oats, wheat, potato, or radish.

In one embodiment, the plant is lettuce.

A specific compound is a trisulfide. The term trisulfide includes compounds that comprise the group —S—S—S— within their structure. For example, in one embodiment, the term trisulfide referes to a compound of formula (I):

R¹—S—S—S—R² (I)

or a salt thereof wherein:
R¹ is (C₁-C₂₀)alkyl, (C₁-C₂₀)alkenyl, (C₁-C₂₀)alkynyl, phenyl, a residue of cysteine, a residue of methionine, a residue of N-acetyl cysteine, a residue of N-acetyl methionine, a residue of homocysteine, a residue of lipoic acid, a residue of coenzyme, a residue of glutathione, or a residue of any other other naturally occurring thiol; and
R² is C₁-C₂₀)alkyl, (C₁-C₂₀)alkenyl, (C₁-C₂₀)alkynyl, phenyl, a residue of cysteine, a residue of methionine, a residue of N-acetyl cysteine, a residue of N-acetyl methionine, a residue of homocysteine, a residue of lipoic acid, a residue of coenzyme, a residue of glutathione, or a residue of any other other naturally occurring thiol.

In one embodiment, the compound of formula (I) is cysteine trisulfide, methionine trisulfide, N-acetylcysteine trisulfide or N-acetyl methionine trisulfide.

In one embodiment, the compound of formula (I) is N-acetyl cysteine trisulfide.

In one embodiment, the term tetrasulfide refers to a compound of formula (II):

R³—S—S—S—S—R⁴ (II)

or a salt thereof, wherein:
R³ is C₁-C₂₀)alkyl, (C₁-C₂₀)alkenyl, (C₁-C₂₀alkynyl, phenyl, a residue of cysteine, a residue of methionine, a residue of N-acetyl cysteine, a residue of fir-acetyl methionine, a residue of homocysteine, a residue of lipoic acid, a residue of coenzyme, a residue of glutathione, or a residue of any other other naturally occurring thiol; and
R⁴ is C₁-C₂₀)aikyl, (C₁-C₂₀)alkenyl, (C₁-C₂₀)alkynyl, phenyl, a residue of cysteine, a residue of methionine, a residue of N-acetyl cysteine, a residue of N-acetyl methionine, a residue of homocysteine, a residue of lipoic acid, a residue of coenzyme, a residue of glutathione, or a residue of any other other naturally occurring thiol.

In one embodiment, the compound of formula (II) is cysteine tetrasulfide, methionine tetrasulfide, N-acetyl cysteine tetrasulfide or N-acetyl methionine tetrasulfide.

In one embodiment, the compound of formula (I) is N-acetyl cysteine tetrasulfide.

The invention will now be illustrated by the following non-limiting Examples.

### EXAMPLES

The synthesis of trisulfides and tetrasulfides is well described in the literature (see for example, Chem. Commun. 2019, 55, 13534-13537; and Moutiez M, et al., Biochemical and Biophysical Research Communications, 1994, 202, 1380-1386). By choosing the right trisulfide or tetrasulfide, a reaction with a thiol will result in the release of hydrogen sulfide and a natural, safe chemical as shown in the following scheme.

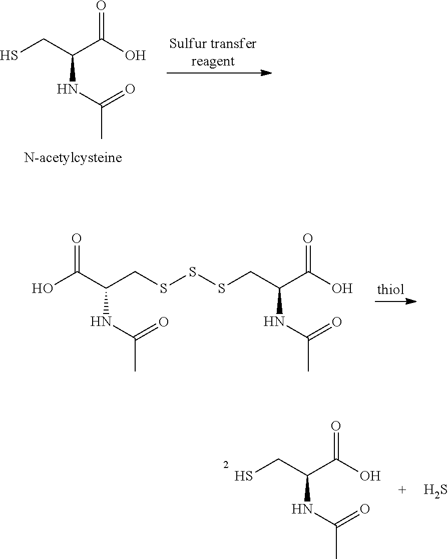

The trisulfide can be synthesized from N-acetylcysteine by reaction with a sulfur transfer reagent such as elemental sulfur, sulfur dichloride, Bunte salt followed by sodium sulfide, and other reagents.

### Example 1. Growth of Lettuce

Lettuce was grown in a nutrient-film technique hydroponic system. The seedlings were grown under LED light film with a 14 hour on time, and a 10 hour off time. The lettuce seeds were purchased from Johnny Selected Seeds. The seed variety was buttercrunch, ID 435 g. The nutrients used were Chem-Gro lettuce formula NPK with micronutrients. Calcium nitrate and magnesium sulfate were also added to the nutrients. The nutrients and the NAC-trisulfide were added to the nutrient bucket, Which was a 4 gallon bucket that recirculated the nutrient solution through the entire NFT system to bathe the roots of the lettuce plants with nutrients and water. An air stone with air pump was used in each nutrient bucket to provide aeration to the nutrient solution. Each different test group of lettuce plants had a separate nutrient reservoir. The nutrient reservoirs were kept pH balanced and nutrient levels were kept steady. The nutrient loading measured in EC (electrical conductivity) would gradually increase as the water was consumed but would return to normal levels once water was added to return the buckets to the max volume of 4 gallons. The conductivity (EC) and pH were measured every 1 to 2 days. Nutrient was added as EC at 4 gallons would approach a value of 0.5 EC. The starting nutrient loading was 1.7 EC, The pH of the nutrient solution was balanced using phosphoric acid “pH down” solution. The pH of the nutrient solution ranged between 6.4-7.4.

The lettuce seeds were started in a separate flood tray. The seeds were sowed into an inert solid support (Oasis Horticubes) and the support absorbed water and nutrients like a sponge. The seedlings were then grown in the seeding hay for 33 days prior to transplant into the channels. At day 42. N-acteyl cysteine trisulfide (NAC trisulfide) was added to the nutrient of the lettuce plants. The NAC trisulfide was weighed as a solid and added as a solid directly to the nutrient reservoir for each set of plants.

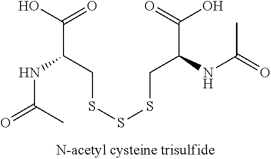 [SMILES: CC(=O)N[C@@H](CSSSC[C@H](NC(C)=O)C(=O)O)C(=O)O]

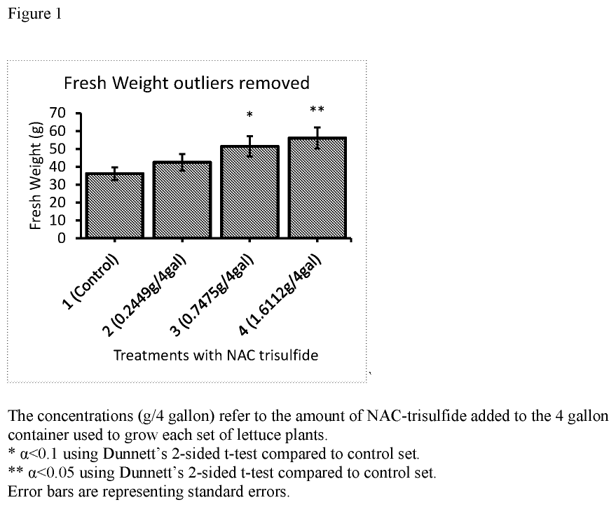

The lettuce plants were harvested by cutting at the root boundary and discarding the roots along with the solid support. The leafy head of lettuce was then weighed to quantify the fresh weight of the lettuce reported in the graphs (see FIG. 1).

| | |
|---|---|
| Seed planting date: Jan. 14, 2020 6:15pm | day 0 |
| Seedling transplant date: 2/16 | day 33 |
| Treatment date: Feb. 25, 2020 6 pm | day 42 |
| Harvest date: Mar. 12, 2020 | day 58 |

Data from the growth experiments is also provided in Table 1.

TABLE 1

| | | | | | | 95% | | | | |
|---|---|---|---|---|---|---|---|---|---|---|
| | | | | | | Confidence | | | | |
| | | | | | | Interval | | | | |
| | | | | | | for Mean | Upper | | | Between- |
| Descriptives | | | Mean | Std. | Std. | Lower | Bound | Minimum | Maximum | Component |
| Fresh Weight (g) | | N | (g) | Deviation | Error | Bound | (g) | (g) | (g) | Variance |
| 1 (Control) | | 34 | 36.13 | 20.71 | 3.55 | 28.91 | 43.35 | 2.03 | 84.75 | |
| 2 (0.2449 g/4 gal) | | 28 | 42.50 | 24.59 | 4.65 | 32.96 | 52.03 | 5.03 | 93.72 | |
| 3 (0.7475 g/4 gal) | | 28 | 51.44 | 30.31 | 5.73 | 39.69 | 63.20 | 11.28 | 113.08 | |
| 4 (1.6112 g/4 gal) | | 28 | 56.07 | 31.18 | 5.89 | 43.98 | 68.16 | 5.39 | 116.18 | |
| Total | | 118 | 46.01 | 27.56 | 2.54 | 40.98 | 51.03 | 2.03 | 116.18 | |
| Model | Fixed | | | 26.74 | 2.46 | 41.13 | 50.88 | | | |
| | Effects | | | | | | | | | |
| | Random | | | | 4.57 | 31.48 | 60.54 | | | 58.67 |
| | Effects | | | | | | | | | |

N: Number of lettuce plants

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1. A method comprising, increasing growth or harvest yield by providing H₂S to a plant or a seed through degradation of a trisulfide or a tetrasulfide.

2. (canceled)

3. A method for increasing growth of a plant or harvest yield of a plant that grows from a seed, comprising contacting the seed with a trisulfide or a tetrasulfide.

4. The method of claim 3 wherein the seed is contacted with the trisulfide or the tetrasulfide prior to planting.

5. The method of claim 3 wherein the seed is contacted with the trisulfide or the tetrasulfide after planting.

6-8. (canceled)

9. The method of claim 1, wherein the plant is a root vegetable, a seed vegetable, or a leaf vegetable.

10. The method of claim 1, wherein the plant is a fruit, flower, flowering plant, vegetable, hemp, or cannabis.

11. The method of claim 1, wherein the plant is a pea, lettuce, tomato, cucumber, green bean, broccoli, squash, beat, onion, sugar, sweet corn, sugar beet, barley, oats, wheat, potato, or radish.

12. The method of claim 1, wherein the plant is lettuce.

13. The method of claim 1, wherein the trisulfide is a compound of formula (I):
R¹—S—S—S—R² (I)
or a salt thereof, wherein:
R¹ is C₁-C₂₀)alkyl, (C₁-C₂₀)alkenyl, (C₁-C₂₀)alkynyl, phenyl, a residue of cysteine, a residue of methionine, a residue of N-acetyl cysteine, a residue of N-acetyl methionine, a residue of homocysteine, a residue of lipoic acid, a residue of coenzyme, a residue of glutathione, or a residue of any other other naturally occurring thiol; and
R² is C₁-C₂₀)alkyl, (C₁-C₂₀)alkenyl, (C₁-C₂₀)alkynyl, phenyl, a residue of cysteine, a residue of methionine, a residue of N-acetyl cysteine, a residue of N-acetyl methionine, a residue of homocysteine, a residue of lipoic acid, a residue of coenzyme, a residue of glutathione, or a residue of any other other naturally occurring thiol.

14. The method of claim 13, wherein the compound of formula (I) is cysteine trisulfide, methionine trisulfide, N-acetyl cysteine trisulfide, N-acetyl methionine trisulfide, or glutathione trisulfide.

15. The method of claim 13, wherein the compound of formula (I) is N-acetyl cysteine trisulfide.

16. The method of claim, wherein the trisulfide is a compound of formula (II):
R³—S—S—S—S—R⁴ (II)
or a salt thereof, wherein:
R³ is C₁-C₂₀)alkyl, (C₁-C₂₀)alkenyl, (C₁-C₂₀)alkynyl, phenyl, a residue of cysteine, a residue of methionine, a residue of N-acetyl cysteine, a residue of N-acetyl methionine, a residue of homocysteine, a residue of lipoic acid, a residue of coenzyme, a residue of glutathione, or a residue of any other other naturally occurring thiol; and
R⁴ is C₁-C₂₀)alkyl, (C₁-C₂₀)alkenyl, (C₁-C₂₀)alkynyl, phenyl, a residue of cysteine, a residue of methionine, a residue of N-acetyl cysteine, a residue of N-acetyl methionine, a residue of homocysteine, a residue of lipoic acid, a residue of coenzyme, a residue of glutathione, or a residue of any other other naturally occurring thiol.

17. The method of claim 13, wherein the compound of formula (II) is cysteine tetrasulfide, methionine tetrasulfide, N-acetyl cysteine tetrasulfide, glutathione tetrasulfide, or N-acetyl methionine tetrasulfide.

18. The method of claim 13, wherein the compound of formula (I) is N-acetyl cysteine tetrasulfide.

19. A composition comprising 1) a trisulfide or a tetrasulfide, 2) a fertilizer, and 3) a suitable agricultural carrier.

20. The composition of claim 19, wherein the trisulfide is a compound of formula (I) or a salt thereof as described in claim 12.

21. The composition of claim 19, wherein the tetrasulfide is a compound of formula (II) or a salt thereof as described in claim 15.

22. (canceled)

23. The composition of claim 19, for administration to a field for increasing growth or harvest yield of a plant grown in the field.

24. (canceled)

25. A kit comprising a trisulfide or a tetrasulfide, packaging material, and instructions for using the trisulfide or the tetrasulfide to increase growth or harvest yield of a plant.
